(19) United States
(12) Patent Application Publication
(10) Pub. No.: US 2016/0261529 A1
(43) Pub. Date: Sep. 8, 2016

(54) METHOD AND APPARATUS FOR MANAGING E-MAIL ATTACHMENTS IN E-MAIL COMMUNICATIONS

(71) Applicant: Motorola Mobility LLC, Chicago, IL (US)

(72) Inventor: Amit Kumar Agrawal, Bangalore (IN)

(21) Appl. No.: 14/636,340

(22) Filed: Mar. 3, 2015

(51) Int. Cl. H04L 12/58; H04L 29/08

(52) U.S. Cl. CPC H04L 51/08; H04L 51/16; H04L 67/02

(57) ABSTRACT

A method and apparatus for managing e-mail attachments in e-mail communications includes an electronic computing device configured to determine that a second e-mail account is receiving from a first e-mail account a first e-mail, of an e-mail thread, having a first e-mail attachment. The method further includes determining that a second e-mail of the e-mail thread is being composed for the second e-mail account and responsively providing a list of received e-mail attachments for the e-mail thread, wherein the list indicates the first e-mail attachment.

### FIELD OF THE DISCLOSURE

The present disclosure relates generally to managing e-mail communications and more particularly to a method and apparatus for providing a list of received e-mail attachments for an e-mail thread from which e-mail attachments are selected.

### BACKGROUND

If sending an e-mail is analogous to delivering a letter by post, then sending an e-mail attachment is analogous to delivering a package. Computer files, such as documents and images, can be sent along with an e-mail to a recipient. These “electronic packages” are attached to an e-mail rather than included within the e-mail to maintain the original format of the computer files. After receiving the files, the recipient can open the files with the same programs that were used to create them. This makes e-mail attachments well-suited for doing business. In some instances, a program file can even be sent as an e-mail attachment and executed on the recipient's client device. E-mail attachments are among the most popular mechanisms for sharing electronic content across computer networks.

For an e-mail thread, multiple participants, each with their own e-mail account, exchange e-mails with one another over a period of time in developing a particular topic. During the course of the e-mail thread, different e-mail attachments may be passed between various participants to the e-mail thread. Some of the e-mail attachments might even be modified versions of previous attachments. The e-mail thread itself can also be dynamic, in the sense that the participants to the e-mail thread change over time. New participants may be added, and existing participants might be removed. For added participants to the e-mail thread, or recipients of e-mails forwarded from the thread, it can be confusing not having been a participant to the e-mail thread from its beginning.

A discussion between market specialists about how to update a product, for example, begins to focus on changing an electronic component within the product. At this point, the market specialists decide to add an electrical engineer to their e-mail thread. The engineer, however, is at a disadvantage by not having received earlier e-mails or e-mail attachments. It is incumbent upon another participant to the e-mail thread to decide which e-mail attachments are needed to bring the engineer up to date and to resend those e-mail attachments to the engineer. Inevitably, the needed e-mail attachments are attached to different e-mails that were received at different times, making it more difficult for the participant to locate the e-mail attachments and to reattach them to a new e-mail. Similar- or like-named e-mail attachments can also make it difficult for the participant to determine if one e-mail attachment is an identical version or a modified version of another previously received e-mail attachment.

### BRIEF DESCRIPTION OF THE FIGURES

The accompanying figures, where like reference numerals refer to identical or functionally similar elements throughout the separate views, form part of the specification and illustrate embodiments in accordance with the included claims.

FIG. 1 illustrates a communication system for sending and receiving e-mails in accordance with an embodiment of the present teachings.

FIG. 2 shows a logical flow diagram illustrating a method of providing a list of received e-mail attachments in accordance with an embodiment of the present teachings.

FIG. 3 illustrates an e-mail server managing e-mail attachments for an e-mail thread in accordance with an embodiment of the present teachings.

FIG. 4 illustrates an e-mail server managing e-mail attachments for an e-mail thread in accordance with an embodiment of the present teachings.

FIG. 5 shows a collapsed list of received e-mail attachments in accordance with an embodiment of the present teachings.

FIG. 6 shows a partially expanded list of received e-mail attachments in accordance with an embodiment of the present teachings.

FIG. 7 shows a block diagram of an e-mail client device used to manage e-mail attachments in accordance with an embodiment of the present teachings.

FIG. 8 shows a block diagram of an e-mail server device used to manage e-mail attachments in accordance with an embodiment of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present teachings. In addition, the description and drawings do not necessarily require the order presented. It will be further appreciated that certain actions and/or steps may be described or depicted in a particular order of occurrence while those skilled in the art will understand that such specificity with respect to sequence is not actually required.

The apparatus and method components have been represented, where appropriate, by conventional symbols in the drawings, showing only those specific details that are pertinent to understanding the embodiments of the present teachings so as not to obscure the disclosure with details that will be readily apparent to those of ordinary skill in the art having the benefit of the description herein.

### DETAILED DESCRIPTION

Generally speaking, pursuant to various embodiments described herein, the present disclosure provides a method and apparatus for managing e-mail attachments in e-mail communications. More specifically, while composing a new e-mail or forwarding a received e-mail, a participant in an e-mail thread is presented with a list of previously received e-mail attachments for the e-mail thread. From the list, the participant can select e-mail attachments to send with his outgoing email.

In accordance with the teachings herein, a method performed by an electronic computing device for managing e-mail attachments in e-mail communications includes determining that a second e-mail account is receiving from a first e-mail account a first e-mail, of an e-mail thread, having a first e-mail attachment. The method further includes determining that a second e-mail of the e-mail thread is being composed for the second e-mail account and responsively providing a list of received e-mail attachments for the e-mail thread, wherein the list indicates the first e-mail attachment.

Also in accordance with the teachings herein is an electronic computing device configured to manage e-mail attachments in e-mail communications that comprises at least one communication interface configured to receive and send e-mail communications. The electronic computing device additionally comprises a processing element operatively coupled to the at least one communication interface, wherein the processing element is configured to determine that a second e-mail account is receiving from a first e-mail account a first e-mail, of an e-mail thread, having a first e-mail attachment. The processing element is further configured to determine that a second e-mail of the e-mail thread is being composed for the second e-mail account and responsively provide a list of received e-mail attachments for the e-mail thread, wherein the list indicates the first e-mail attachment. The processing element is also configured to detect a selection of a set of outgoing e-mail attachments from the list of received e-mail attachments, wherein the set of outgoing e-mail attachments is attached to the second e-mail.

An e-mail or electronic mail, as used herein, refers to an electronic transmission and distribution of a message over a computer network from one electronic computing device to another. The message may be a written message encoded as text using the American Standard Code for Information Interchange (ASCII), Unicode, or any other character-encoding scheme. Networks include, but are not limited to, local area networks (LANs), metropolitan area networks (MANs), campus area networks (CANs), wide area networks (WANs), and the Internet. An e-mail is sent by an author or originator of the e-mail via an e-mail account of the originator to one or more recipients of the e-mail via e-mail accounts belonging to the recipients. Composing an e-mail, as used herein, includes both drafting a new e-mail or forwarding a previously received e-mail.

An e-mail account is an arrangement with a company, government, educational institution, or other entity which allows the e-mail account to send and receive e-mail messages via an e-mail system or electronic infrastructure configured to pass e-mails between e-mail accounts using e-mail addresses. An e-mail address identifies an e-mail box to which e-mail messages are delivered for retrieval by a recipient of the e-mail messages. An example e-mail address includes a domain separated from a unique identifier for the domain by an “@” symbol. The unique identifier identifies an e-mail account, and in some instances, also an owner of the e-mail account, for example, “jane.doe@pineville.gov” or “treasurer@pineville.gov.”

An e-mail attachment, as used herein, refers to an electronic file or a pointer to an electronic file that is sent along with an e-mail to provide a recipient of the e-mail with access to the electronic file. In a first embodiment, where the electronic file is sent with the e-mail, the recipient may access the file directly from the e-mail. For example, when the recipient downloads the e-mail from an e-mail server to his client device, the attached electronic file is downloaded with the e-mail. The recipient may then open the electronic file on his client device provided the client device is equipped with software and/or hardware configured to open electronic files having the same format as the attached electronic file.

For a second embodiment, a pointer to the electronic file, rather than the electronic file itself, is sent with the e-mail as an e-mail attachment. A pointer, as used herein, represents a symbolic association, a soft link, or a logical connection to an electronic file. After opening the e-mail, the recipient of the e-mail is presented with the pointer that provides an electronic link to the electronic file, which is stored remotely from the client device. For example, the pointer sent with the e-mail is a uniform resource locater (URL) that provides an Internet address to a file server on which the electronic file is stored. By navigating to the Internet address specified by the URL using a web browser, or by clicking on the URL if it is hyperlinked, the e-mail recipient is directed to the electronic file, which he may then download to his client device from the remote file server.

An electronic computing device, also referred to herein simply as an electronic device, is any device that has the ability to transmit, receive, route, and/or deliver an e-mail with or without an e-mail attachment. For example, an electronic device can include, but is not limited to, servers, home and office computers, tablets, phablets, and smartphones, each of which has a processing element and can execute an e-mail program.

An electronic device having a processing element and executing a client-based or web-based e-mail program or an electronic device configured at a hardware level to operate as an e-mail client is referred to herein as an “e-mail client device” or simply as a “client device.” A client device is configured to send, receive, and compose e-mails. For client-based e-mail that is loaded directly onto a client device, the client device might execute an e-mail program such as Microsoft Outlook or Mozilla Thunderbird. For web-based e-mail that is viewed on the Internet, a client device might use a web browser, such as Mozilla Firefox or Microsoft Explorer, to browse to a web-based e-mail client program, such as Gmail or Yahoo Mail.

An electronic computing device can also include an e-mail server device, also referred to herein simply as “e-mail server,” that routes and delivers e-mails. An electronic computing device can also include a network- or web-based file server and/or a network- or web-based server hosting an e-mail software program that is accessed remotely from a different location.

When a meaning is clear from context, strict adherence to distinguishing between e-mail accounts and account owners is sometimes relaxed for brevity and/or readability. For instance, “Bill sends an e-mail to Bob” might be written in place of and understood to mean that “Bill uses his e-mail account and an electronic computing device running an e-mail client program to send an e-mail to an e-mail account belonging to Bob.”

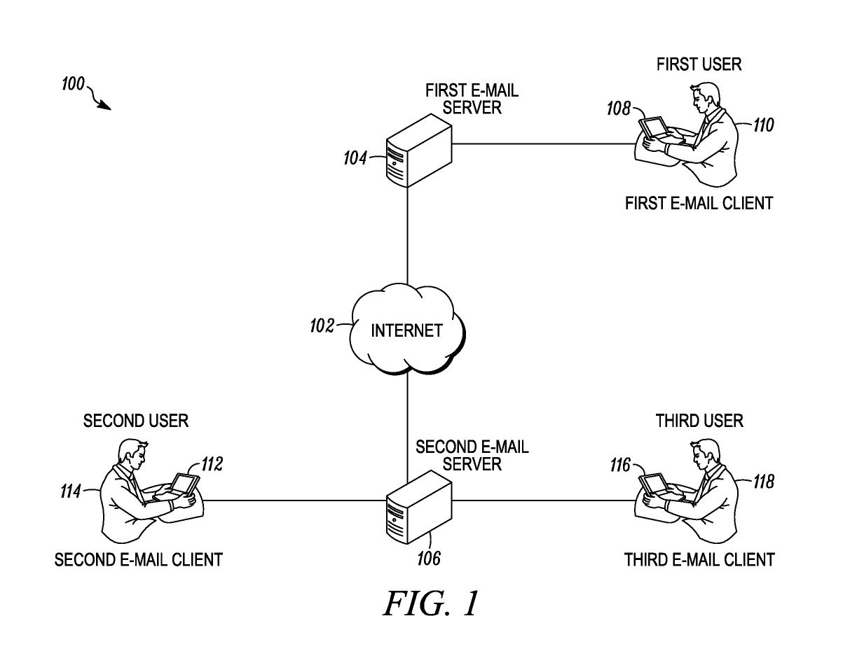

Referring now to the drawings, FIG. 1 shows an e-mail system 100 that includes a first e-mail server 104 and a second e-mail server 106 used to communicate e-mail messages over the Internet 102 between a user 110 associated with a first domain and users 114 and 118 associated with a second domain. In one example scenario, the email system 100 is used by the first user 110 of the e-mail system 100 to send an e-mail across the Internet 102 to the second 114 and third 118 user of the e-mail system 100. When the first user 110 uses a computer, smartphone, or other electronic device operating as an e-mail client device 108 to author and send the e-mail, the e-mail is transmitted to a Simple Mail Transfer Protocol (SMTP) server included within the first e-mail server 104 that serves the first domain to which the first user's e-mail account belongs. From recipient e-mail addresses included with the e-mail sent by the first user 110, the SMTP server determines that e-mail accounts of the second 114 and third 118 users belong to the second domain.

The SMTP server queries a domain name server (DNS) for an Internet Protocol (IP) address of the second e-mail server 106, which serves the second domain. The SMTP server then transmits the e-mail to the second e-mail server 106 using the IP address. A post office protocol (POP) or an internet message access protocol (IMAP) server included within the second e-mail server 106 stores copies of the e-mail in files associated with the e-mail accounts of the second 114 and third 118 users as determined from the unique indentifies included in the recipient e-mail addresses. The second 114 and third 118 users retrieve the e-mail from the POP or IMAP server when they next access their e-mail accounts, for example, by using e-mail client devices 112 and 116, respectively, to connect with the second e-mail server 106.

The second 114 user can also use his e-mail account to send a reply e-mail back to the first user 110 and copy the third user 118. Using the electronic device 112 and his e-mail account, the second user 114 transmits the reply e-mail to the second e-mail server 106. The second e-mail server 106 determines from the e-mail address of the third user 118 included with the reply e-mail that the e-mail account of the third user 118 belongs to the second domain. The second e-mail server 106 simply passes a copy of the reply e-mail from an SMTP server included within the second e-mail server 106 to its POP or IMAP server for delivery. The second e-mail server 106 uses an IP address of the first e-mail server 104 to transmit another digital copy of the reply e-mail to a POP or IMAP server within the first e-mail server 104 for delivery to the first user 110.

A passing of one or more e-mails and at least one reply e-mail between two or more participants, or more accurately, between e-mail accounts of the two or more participants, results in an e-mail thread. Any participant's e-mail account that is involved in an e-mail thread can receive an e-mail of the e-mail thread as an ordinary recipient account, a carbon copy (CC) recipient account, or a blind carbon copy (BCC) recipient account of the e-mail thread.

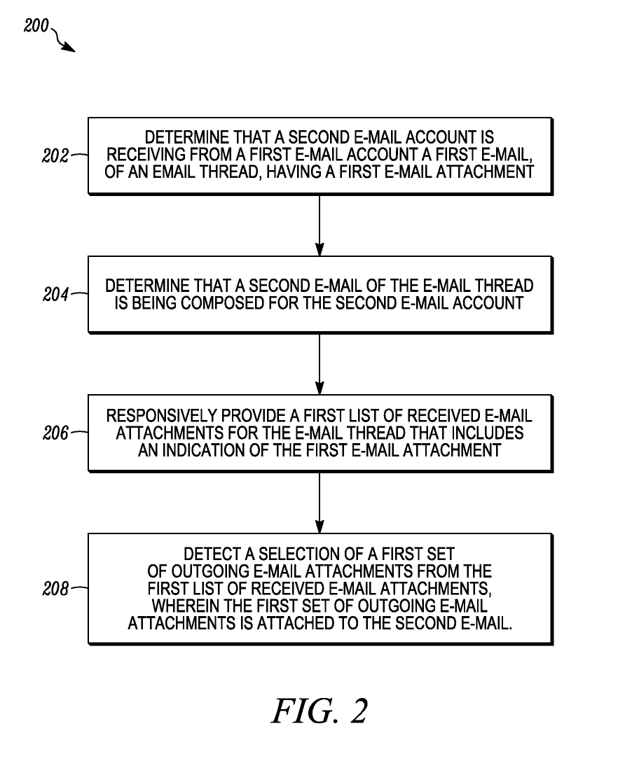

By way of a logical flow diagram, FIG. 2 illustrates a method 200 performed by an electronic computing device for managing e-mail attachments in e-mail communications. Specifically, an electronic computing device determines 202 that a second e-mail account is receiving a first e-mail from a first e-mail account, wherein the first e-mail has a first e-mail attachment. The electronic computing device identifies an e-mail thread for the first e-mail that includes the first and second e-mail accounts. Users of e-mail accounts included within an e-mail thread are referred to herein as participants to the e-mail thread. Participants are individuals who compose e-mails, select e-mail attachments, and send e-mails using their e-mail accounts. Participants to an e-mail thread additionally include those individuals using their e-mail accounts to receive e-mails included in the e-mail thread.

The electronic computing device also determines 204 that a second e-mail in the e-mail thread is being composed using the second e-mail account. The second e-mail may follow directly after the first e-mail. Alternatively, other e-mails in the e-mail thread may have been composed, sent, and received by participants of the e-mail thread after a first participant sent the first e-mail but before a second participant uses the second e-mail account to compose the second e-mail. In either case, recipients of the second e-mail may include any participants of the e-mail thread. For different embodiments, the second participant clicking a “reply,” “reply all,” or a “forward” icon within his e-mail client signals the electronic computing device that the second e-mail is being composed.

In response to the second participant composing the second e-mail, the electronic computing device provides 206 a first list of received e-mail attachments for the e-mail thread that includes an indication of the first e-mail attachment. Received e-mail attachments are those e-mail attachments that have been sent with an e-mail of the e-mail thread and received using the e-mail account of at least one participant to the e-mail thread. An indication of an e-mail attachment on a list of received e-mail attachments, as used herein, means that the e-mail attachment is represented in the list and not omitted from the list. Where the e-mail attachment is a computer file, for example, the name of the computer file, or other identifying information, would appear in the list of received e-mail attachments.

The electronic computing device provides 206 the first list of received e-mail attachments by making the list available to the second participant for his consideration and use in accordance with the teachings herein. For an embodiment, the electronic computing device provides 206 the first list of received e-mail attachments using a client device being used by the second participant to compose the second e-mail. Where the client device has a display screen, for instance, the first list of received e-mail attachments is shown on the display screen. In a further embodiment, the first list of received e-mail attachments is displayed within the e-mail client application the second participant is using to compose the second e-mail.

For other embodiments, the electronic computing device can provide 206 a list of received e-mail attachments by auditory or haptic means. If the second participant is using a client device without a display screen to compose the second e-mail using voice recognition, for example, the electronic computing device might provide 206 the first list of received e-mail attachments using a text-to-speech capability of the client device. In a further embodiment, the electronic computing device provides 206 lists of received e-mail attachments differently to different participants using different client devices having different capabilities. For example, the electronic computing device might use a display screen of one client device to visually present 206 a list of received e-mail attachments to one participant, and thereafter use speech to present 206 another list of received e-mail attachments to another participant using another client device without a display screen.

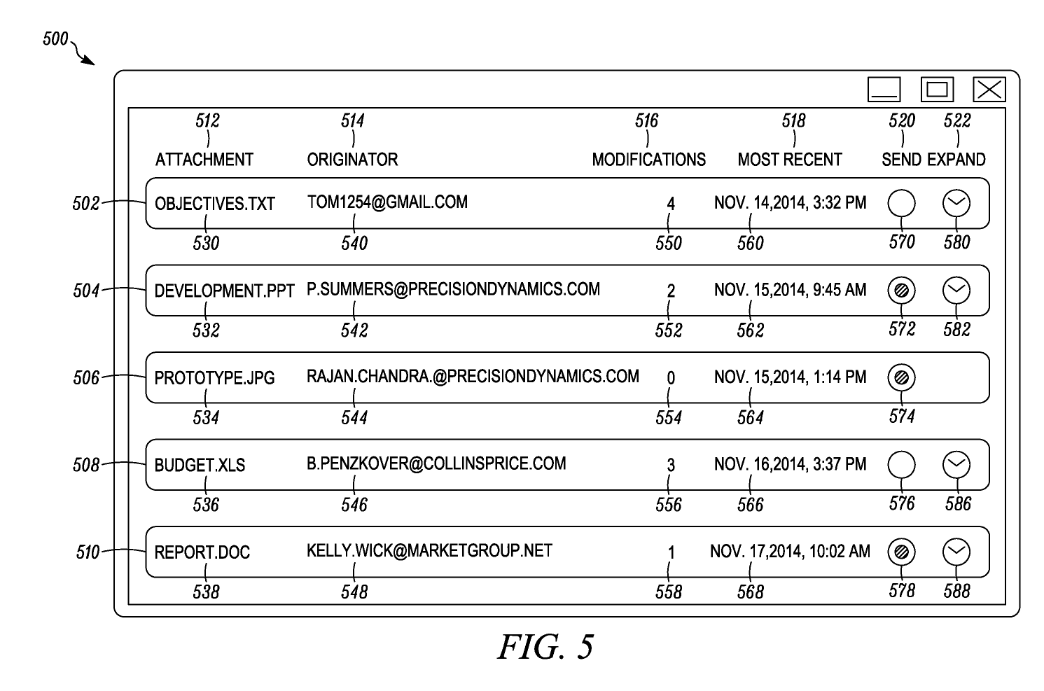

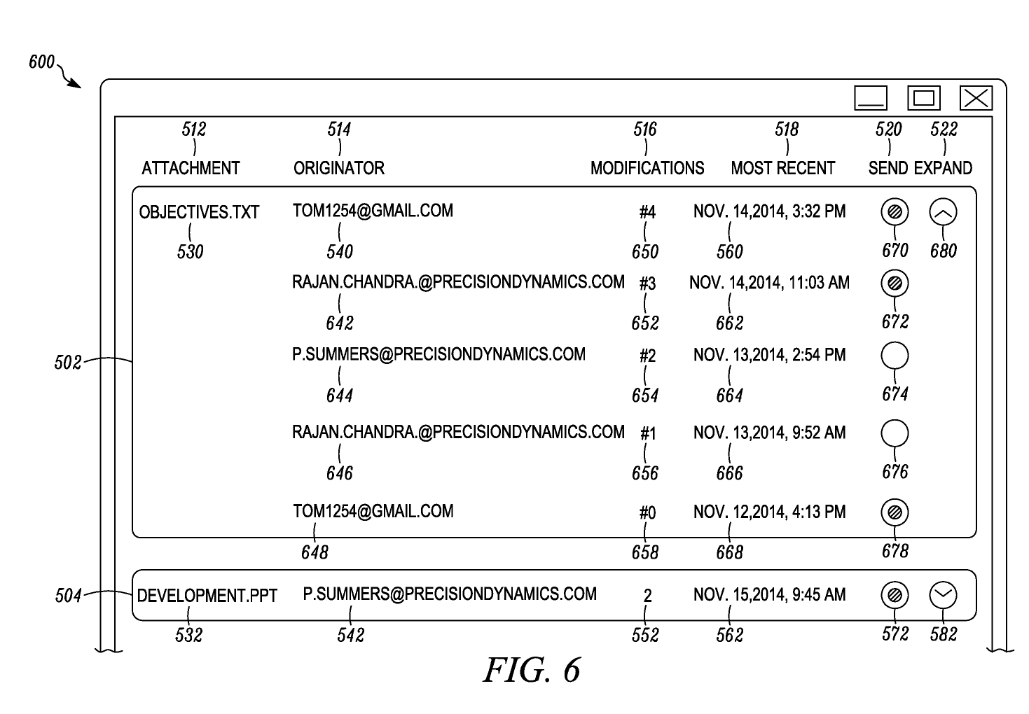

How the electronic computing device provides 206 the first list of received e-mail attachments can also depend on whether the electronic computing device is an e-mail client device or an e-mail server device. If the electronic computing device is an e-mail client device having a display screen, for example, then it provides 206 the first list of received e-mail attachments by presenting the list to the second participant on its display screen. If, on the other hand, the electronic computing device is an e-mail server device, then it provides 206 the first list of received e-mail attachments by messaging the list to the e-mail client device being used to compose the second e-mail, which, in turn, presents the list to the second participant. A more detailed description for the presentation of a list of received e-mail attachments is provided with reference to FIGS. 5 and 6.

Upon being presented with the first list of received e-mail attachments, the second participant considers whether he would like to send any attachments indicated in the list with the second e-mail he is currently composing. If the second participant wishes to attach e-mail attachments indicated in the first list of received e-mail attachments, he selects those attachments from the list. The electronic computing device then detects 208 the selection of the chosen e-mail attachments from the first list of received e-mail attachments as a first set of outgoing e-mail attachments. As used herein, a set of outgoing e-mail attachments may include multiple e-mail attachments or only a single e-mail attachment.

After detecting 208 the selection of the first set of outgoing e-mail attachments, the set of selected e-mail attachments is attached to the second e-mail for delivery with the second e-mail. For one embodiment, the electronic computing device attaches the first set of outgoing e-mail attachments to the second e-mail. In different embodiments, either the e-mail client device or the e-mail server device attaches the first set of outgoing e-mail attachments to the second e-mail. The first set of outgoing e-mail attachments is then sent out with the second e-mail, for example, when the second participant clicks on the “send” icon from within his e-mail client application.

In one instance, the electronic computing device determines that a third e-mail account to the e-mail thread is receiving the second e-mail and the second e-mail attachment from the second e-mail account. The electronic computing device also determines that the second e-mail is an initial e-mail in the e-mail thread to which the second e-mail attachment was attached and adds the second e-mail attachment to the current list of e-mail attachments.

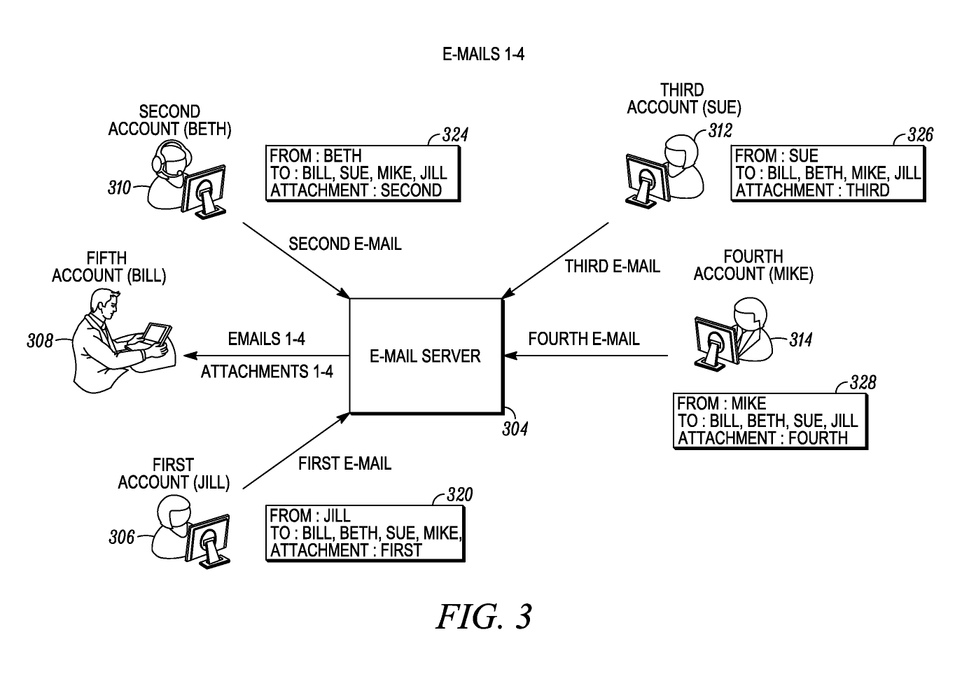

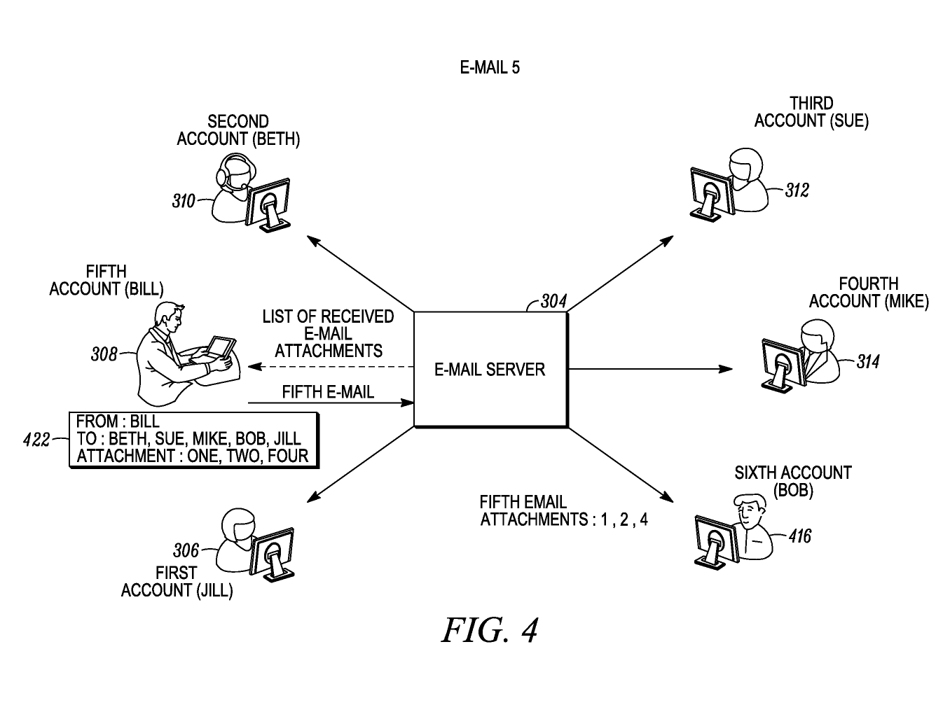

For a further embodiment, the electronic computing device determines that a third e-mail of the e-mail thread is being composed for the third e-mail account by a third participant. The electronic computing device responsively provides a second list of received e-mail attachments for the e-mail thread to present to the third participant, wherein the second list indicates the second e-mail attachment. The third participant selects a second set of outgoing e-mail attachments from the second list of received e-mail attachments, which is then attached to the third e-mail for delivery. The method 200 for managing e-mail attachments is also illustrated by FIGS. 3 and 4.

FIG. 3 shows four participants Jill 306, Beth 310, Sue 312, Mike 314 to an e-mail thread each of whom sends a different e-mail having an e-mail header 320, 324, 326, 328 and a different e-mail attachment to the other three participants and a fifth participant Bill 308 to the e-mail thread. Jill 306, using her client device and a first e-mail account, sends a first e-mail. As indicated in the header 320, the first e-mail is sent with a first e-mail attachment to Beth 310, Sue 312, Mike 314, and Bill 308. Beth 310, in turn, uses her client device to send a second e-mail having a second e-mail attachment to Jill 306, Sue 312, Mike 314, and Bill 308, as indicated by the e-mail header 324. The e-mail header 326 shows that Sue 312 uses her client device and a third e-mail account to send a third e-mail having a third e-mail attachment to Jill 306, Beth 310, Mike 314, and Bill 308. Eventually, as indicated by the e-mail header 328, Mike 314 sends a fourth e-mail having a fourth e-mail attachment to Jill 306, Beth 310, Sue 312, and Bill 308. In each case, an e-mail server 304 receives and delivers each e-mail with its respective e-mail attachment to the indicated recipients. Bill 308 receives four e-mail attachments sent between participants 306, 308, 310, 312, 314 of the e-mail thread, as shown.

After receiving the fourth e-mail, Bill 308 begins to compose a fifth e-mail he intends to send. This is shown in FIG. 4. When Bill 308 clicks a “reply,” “reply all,” or “forward” icon from within an e-mail client application he is using to draft the fifth e-mail, his client device, on which the e-mail client application is executing, sends a notification to the e-mail server 304. The e-mail server 304 is configured to respond to this notification by providing Bill's client device with a list of received e-mail attachments, which is then presented to Bill 308 by his client device. For an embodiment, the list of received e-mail attachments includes an indication of each e-mail attachment, e.g., attachments 1, 2, 3, and 4, Bill 308 previously received to his e-mail account for the e-mail thread. Optionally, the list of received e-mail attachments can be generated and provided by Bill's client device rather than by the e-mail server 304. Therefore, the list of received e-mail attachments is represented in FIG. 4 by a broken arrow.

As successive e-mails are sent for the e-mail thread, the e-mail server 304 determines a current list of e-mail attachments received collectively by a plurality of e-mail accounts participating in the e-mail thread. For an embodiment, the current list of e-mail attachments includes an indication of every e-mail attachment sent for the e-mail thread. As Jill 306, Beth 310, Sue 312, and Mike 314 each send their e-mail, for example, the e-mail server 304 adds an indication of the first, second, third, and fourth e-mail attachment, respectively, to the current list of e-mail attachments.

For some embodiments, the list of received e-mail attachments the e-mail server 304 provides to Bill's client device is a subset of the current list of e-mail attachments. In one embodiment, the e-mail server 304 includes in the list of received e-mail attachments it provides to Bill's client device only those e-mail attachments that were sent to Bill's e-mail account. When the list of received e-mail attachments is presented to Bill 308, he can select from the list any combination of e-mail attachments he received to his e-mail account during the course of the e-mail thread. In another embodiment, the list of received e-mail attachments also includes e-mail attachments that were sent from Bill's e-mail account.

A header 422 to the fifth e-mail indicates Bill 308 is adding Bob 416 to the e-mail thread. Bob 416 is currently at a disadvantage because he was not previously a participant to the e-mail thread when the first, second, third, and fourth e-mail attachments were initially sent out. To provide Bob 416 with information he will need to be an informed participant, Bill 308 decides to send Bob 416 the first, second, and fourth e-mail attachments that Bill 308 received previously. Bill 308 selects the first, second, and fourth e-mail attachments from the list of received e-mail attachments presented to him. After his selection, the first, second, and fourth e-mail attachments are attached to the fifth e-mail. In one embodiment, Bill's client device communicates his selection to the e-mail server 304, and the e-mail server 304 then attaches the set of outgoing e-mail attachments to the fifth e-mail. In another embodiment, it is Bill's client device that attaches the set of outgoing e-mail attachments to the fifth e-mail. Upon receiving the fifth e-mail to his e-mail account, Bob 416 can access the first, second, and fourth e-mail attachments.

For one embodiment, at least one e-mail attachment of the first set of outgoing e-mail attachments is an electronic link that points to an electronic file. In a further embodiment, the electronic link is a hyperlink. The hyperlink can be a hyper-text-markup-language hyperlink, a extensible-markup-language hyperlink, or any other type of hyperlink that links to an electronic file. For another embodiment, the first set of outgoing e-mail attachments includes a combination of electronic files and pointers to electronic files.

FIG. 5 shows a window 500 that for an embodiment illustrates how a list of received e-mail attachments might be visually presented on a display screen of a client device. The list is shown within the window 500 is arranged as a table having five rows 502, 504, 506, 508, 510 and six columns 512, 514, 516, 518, 520, 522. Each of the five rows 502, 504, 506, 508, 510 represents an e-mail attachment, which is indicated in the first column 512. Beginning with the uppermost row 502, an “objectives” text file 530 is indicated, followed by a “development” slide deck 532 in row 504, a “prototype” image file 534 in row 506, a “budget” spreadsheet file 536 in row 508, and a “report” document file 538 in row 510. For a number of embodiments, the list of received e-mail attachments also includes various types of metadata associated with each listed e-mail attachment.

For one embodiment, an electronic computing device that manages e-mail attachments in accordance with the present teachings determines from which e-mail account an e-mail attachment originated for each e-mail attachment indicated in a current list of e-mail attachments for an e-mail thread. This information is then included in lists of received e-mail attachments generated from the current list of e-mail attachments. Which e-mail account first sent an e-mail attachment is indicated in column 514 for the list of received e-mail attachments shown in window 500. Specifically, the e-mail attachment 530 was first sent from an account tom1254@gmail.com 540, the e-mail attachment 532 was first sent from an account p.summers@precisiondynamics.com 542, the e-mail attachment 534 was first sent from an account rajan.chandra@precisiondynamics.com 544, the e-mail attachment 536 was first sent from an account b.penzkover@collinsprice.com 546, and the e-mail attachment 538 was first sent from an account kelly.wick@marketgroup.net 548.

In a further embodiment, the electronic computing device also determines which e-mail attachments indicated in the current list of e-mail attachments are modified versions of previously sent e-mail attachments. If, for example, one participant sends out an electronic file as an e-mail attachment and a recipient of that electronic file modifies the file and again sends it out as an e-mail attachment, then one original version and one modified version of that e-mail attachment will be indicated in the current list of e-mail attachments. The list of received e-mail attachments shown in the window 500 includes this information in column 516. The original version of the “objectives” text file 530 was modified and sent out again as an e-mail attachment four times, as indicated at 550. Column 516 also shows that the electronic files 532, 536, and 538 were modified and attached to subsequent e-mails two, three, and one time, as indicated at 552, 556, and 558, respectively. The image file “prototype” 534 was sent as an e-mail attachment only once, without any modified versions being sent out later, as indicated at 554.

In different embodiments, the electronic computing device uses different techniques and/or information to determine if an e-mail attachment is a modified version of a previously sent e-mail attachment. For one embodiment, an electronic file sent as an e-mail attachment having a same name but a different memory size as a previously sent e-mail attachment serves as an indication that the e-mail attachment is a modified version of the previously sent e-mail attachment.

In another embodiment, the electronic computing device compares the contents of two electronic files by executing a comparative algorithm to determine if the two files are sufficiently similar without being identical. If the similarity between the two electronic files falls within a range, for example, between one and ten percent, then the electronic computing device determines that the later of the two files is a modified version of the other, earlier-sent file.

For a third embodiment, the electronic computing device compares electronic files having the same name using a hash function to determine if the contents of the two files are identical. A hash function is the application of an algorithm to a file that generates a unique string of data (a hash value) for the file based on the contents of the file. The hash value serves as a “digital fingerprint” for the file and will only match the hash value for another file if the two files are identical.

As shown in the column 518, the electronic computing device indicates, in the list of received e-mail attachments, a most recent e-mail attachment, from a series of subsequently modified e-mail attachments, originating from a same previously received e-mail attachment of the e-mail thread. The fourth and latest modified version of the “objectives” text file 530, for example, was sent out as an e-mail attachment on Nov. 14, 2014, at 3:32 pm, as indicated at 560. The following day, as indicated at 562 and 564, the second and most recent modification of the “development” slide deck 532 was sent out as an e-mail attachment, and also the original and only version of the “prototype” image file 534. On November 16^{th} and 17^{th}, respectively, the third modification of the “budget” spreadsheet file 536 and the only modification of the “report” document file 538 were sent out as e-mail attachments.

The column 520 shows five radio buttons 570, 572, 574, 576, 578, one for each indication of an electronic file appearing in the list of received e-mail attachments. A participant presented with the list of received e-mail attachments while composing an e-mail would click on the radio buttons corresponding to those electronic files he wants to attach to his e-mail. The window 500 shows that radio buttons 572, 574, and 578 are clicked on, as indicated by dark inner circles, resulting in the electronic computing device attaching the most recent versions of the “development” slide deck 532, the “prototype” image file 534, and the “report” document file 538 to the participant's e-mail as e-mail attachments.

The participant composing the e-mail also has the option of sending out as an e-mail attachment one or more versions of an electronic file when one or more modified versions of the electronic file have been previously received by the participant as e-mail attachments. In rows 502, 504, 508, and 510, for which modified versions of e-mail attachments have been received, the window 500 shows “expand” buttons in column 522 at 580, 582, 586, and 588, respectively. The participant clicks upon an expand button to show all versions of a corresponding electronic file the participant has received in previous e-mails. A partially expanded view of the list of received e-mail attachments shown in the window 500 is provided by FIG. 6.

FIG. 6 shows in a window 600 the list of received e-mail attachments for which the participant has clicked on the expand button 580 to reveal each version of the “objectives” text file 530 the participant received. Other expand buttons 582, 586, 588 can also be clicked on to independently or concurrently expand additional rows 504, 508, 510, respectively, of the list of received e-mail attachments.

For each modified version of a previously sent e-mail attachment, the electronic computing device determines from which e-mail account the modified version originated. For an embodiment, this information is included in the list of received e-mail attachments. The list of received e-mail attachments indicates which e-mail account originated each listed e-mail attachment, and indicates which e-mail account originated each listed modified version of a previously received e-mail attachment. While row 502 is expanded, the participant sees each version of the “objectives” text file 530, numbered in column 516 in order from most recent to earliest at 650, 652, 654, 656, and 658. In the same order, the email account that e-mailed each version of the file 530 is indicated at 540, 642, 644, 646, and 648, while the time of each e-mail is indicated at 560, 662, 664, 666, and 668, respectively. The original version of the “objectives” text file 530, for example, was sent from the e-mail account tom1254@gmail.com at 4:13 pm on November 12^{th}. The first and third modified versions of the electronic file 530 were both sent from the account rajan.chandra@precisiondynamics.com on November 13th, at 9:52 am, and on November 14, at 11:03 am, respectively.

Expanding row 502 provides additional radio buttons 670, 672, 674, 676, 678 in the column 520, allowing the participant to select any combination of versions of the “objectives” text file 530 he would like attached to his outgoing e-mail. As shown in the window 600, the participant selects the most recent version, the original version, and also the third modified version of the “objectives” text file 530 by clicking on radio buttons 670, 678, and 672, respectively. For an embodiment, the electronic computing device detects the selections and attaches the multiple versions of the file 530 to the participant's outgoing e-mail. For another embodiment, the participant also attaches a fresh e-mail attachment. A fresh e-mail attachment is an electronic file or a pointer to an electronic file that that has not previously been sent and therefore does not appear in the list of received e-mail attachments.

In expanding the row 502 of the list of received e-mail attachments, the expand button 580 changes to a collapse button 680. When the participant clicks on the collapse button 680, the partially expanded view of the list of received e-mail attachments collapses back down to the view of the list shown in the window 500. For an embodiment, each row of the list of received e-mail attachments for which there are one or more modified versions of an indicated electronic file is independently expandable and collapsible. Different embodiments may also feature different means by which portions of a list of received e-mail attachments may be expanded and/or collapsed. For example, the expand button 580 may appear with a “+” symbol, and the collapse button 680 may appear with a “−” symbol. In another example, the participant may click anywhere within a blank space of a portion of a list of received e-mail attachments to toggle that portion of the list between an expanded view and a collapsed view.

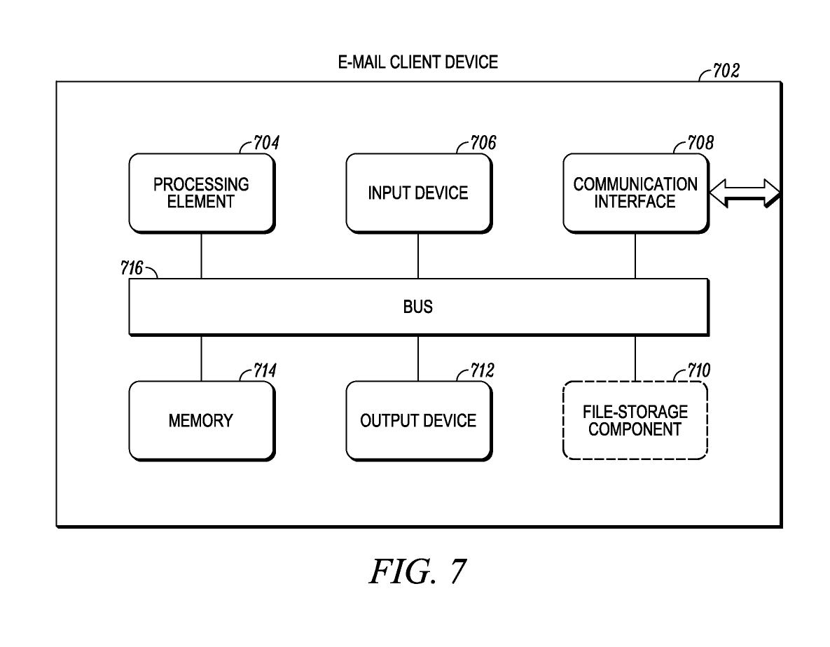

In a first embodiment, the electronic computing device performing the method 200 for managing e-mail attachments is configured to operate as an e-mail client device. FIG. 7 shows a block diagram of such an e-mail client device 702. Included within the block diagram is a processing element 704, an input device 706, a communication interface 708, an optional file-storage component 710, an output device 712, and memory 714, which are all operationally interconnected by a bus 716. A limited number of device components 704, 706, 708, 710, 712, 714, and 716 are shown at 702 for ease of illustration, and other embodiments may include a lesser or greater number of components in an e-mail client device. Moreover, other components needed for a commercial embodiment of an e-mail client device that incorporates the components shown at 702 are omitted from FIG. 7 for clarity in describing the enclosed embodiments.

In general, the processing element 704 is configured with functionality in accordance with embodiments of the present disclosure as described in herein with respect to FIGS. 1, 2, 3, 4, 5, and 6. “Adapted,” “operative,” “capable” or “configured,” as used herein, means that the indicated components are implemented using one or more hardware elements, such as one or more operatively coupled processing cores, memory elements, and interfaces, which may or may not be programmed with software and/or firmware, as the means for the indicated components to implement their desired functionality. Such functionality is supported by the other hardware shown in FIG. 7, including the device components 706, 708, 710, 712, and 714, which are all operatively interconnected with the processing element 704 by the bus 714.

The processing element 704, for instance, includes arithmetic logic and control circuitry necessary to perform the digital processing, in whole or in part, for the e-mail client device 702 to manage e-mail attachments in accordance with described embodiments for the present teachings. For one embodiment, the processing element 704 represents a primary microprocessor, also referred to as a central processing unit (CPU), of the e-mail client device 702. For example, the processing element 704 can represent an application processor of a tablet. In another embodiment, the processing element 704 is an ancillary processor, separate from the CPU, wherein the ancillary processor is dedicated to providing the processing capability, in whole or in part, needed for the device components of the e-mail client device 702 to perform at least some of their intended functionality.

The memory 714 provides storage of electronic data used by the processing element 704 in performing its functionality. For example, the processing element 704 can use the memory 714 to store received e-mail attachments and/or metadata for the received e-mail attachments. In one embodiment, the memory 714 represents random access memory (RAM). In other embodiments, the memory 714 represents volatile or non-volatile memory. For a particular embodiment, a portion of the memory 714 is removable. For example, the processing element 704 can use RAM to cache data while it uses a micro secure digital (microSD) card to store received e-mail attachments.

The communication interface 708 allows for communication between the e-mail client device 702 and other electronic devices, such as an e-mail server device or a file-storage device, configured to support the e-mail client device 702 in performing its described functionality. For one embodiment, the communication interface 708 uses a cellular transceiver to enable the e-mail client device 702 to communicate with other devices using one or more cellular networks. Cellular networks can use any wireless technology that, for example, enables broadband and Internet Protocol (IP) communications including, but not limited to, 3^{rd} Generation (3G) wireless technologies such as CDMA2000 and Universal Mobile Telecommunications System (UMTS) networks or 4^{th} Generation (4G) wireless networks such as LTE and WiMAX.

In another embodiment, the communication interface 708 uses a wireless local area network (WLAN) transceiver that allows the e-mail client device 702 to access the Internet using standards such as Wi-Fi. The WLAN transceiver allows the e-mail client device 702 to send and receive radio signals to and from similarly equipped electronic devices using a wireless distribution method, such as a spread-spectrum or orthogonal frequency-division multiplexing (OFDM) method. For some embodiments, the WLAN transceiver uses an IEEE 802.11 standard to communicate with other electronic devices in the 2.4, 3.6, 5, and 60 GHz frequency bands. In a particular embodiment, the WLAN transceiver uses Wi-Fi interoperability standards as specified by the Wi-Fi Alliance to communicate with other Wi-Fi certified devices.

For additional embodiments, the communication interface 708 uses hard-wired, rather than wireless, connections to a network infrastructure that allows the e-mail client device 702 to communicate electronically with other devices. For example, the communication interface 708 includes a socket that accepts an RJ45 modular connector which allows the e-mail client device 702 to be connected directly to a network router by category-5 or category-6 Ethernet patch cable. The communication interface 708 can also use a cable modem or a digital subscriber line (DSL) to connect with an e-mail server through the Internet via an internet service provider (ISP).

The file-storage component 710 represents one or more data storage devices configured, for an embodiment, to store electronic files that have been sent and received as e-mail attachments. In additional embodiments, the file-storage component 710 can store metadata associated with the electronic files or pointers to the electronic files when the electronic files are being hosted by another device, such as a web server, for example. The file-storage component 710 can include, but is not limited to, magnetic hard drives, solid-state drives, network-attached storage, optical storage devices, tape storage devices, or any combination thereof. The file-storage component 710 is shown as an optional component with a broken line because for some embodiments, it is not co-located with the e-mail client device 702. For example, the file-storage component 710 may include cloud storage that is communicatively coupled to the communication interface 708 or it may be co-located with an e-mail server device.

The input device 706 and the output device 712 represent user-interface components of the e-mail client device 702 configured to allow a person to use, program, or otherwise interact with the e-mail client device 702. For example, a mouse is an input device that allows a participant to launch an e-mail client software application or to click on icons from within the application. A keyboard is an input device that allows a participant to type an e-mail message. A microphone is an input device that allows a participant dictate an e-mail message. The participant may also compose an e-mail using a touchscreen, which serves as both an input device and an output device. Functioning as an output device, for example, the touchscreen allows the participant to view a list of received e-mail attachments. Functioning as an input device, the touchscreen also allows the participant to select e-mail attachments from the list of received e-mail attachments.

As the e-mail client device 702 receives e-mail attachments with incoming e-mails, it saves the e-mail attachments to the file-storage component 710. The e-mail client device 702 also creates a current list of e-mail attachments and appends the list with each new e-mail attachment it receives. When a participant composes an e-mail, the e-mail client device 702 uses the output device 712 to present the participant with a list of received e-mail attachments taken from the current list of e-mail attachments. The participant uses the input device 706 to select e-mail attachments from the list of received e-mail attachments, and the e-mail client device 702 retrieves the selected e-mail attachments from the file storage component 710 and attaches them to the participant's outgoing e-mail.

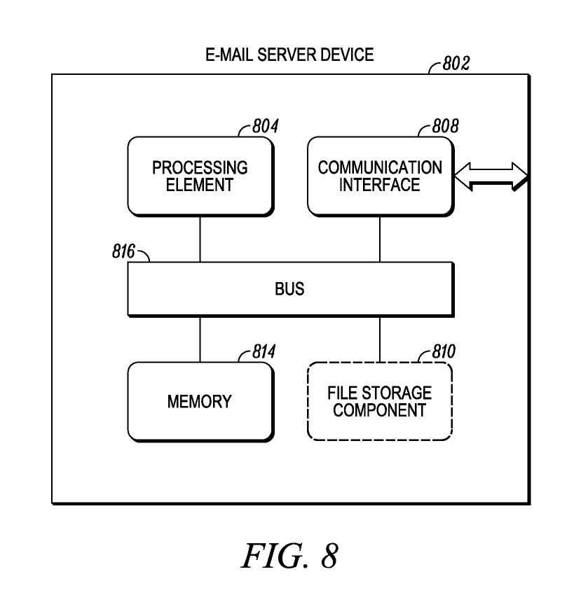

In a second embodiment, the electronic computing device is configured to operate as an e-mail server device. FIG. 8 shows a block diagram of such an e-mail server device 802. Included within the block diagram is a processing element 804, a communication interface 808, an optional file-storage component 810, and memory 814, which are all operationally interconnected by a bus 816. A limited number of device components 804, 808, 810, 814, 816 are shown within the e-mail server device 802 for ease of illustration, and other embodiments may include a lesser or greater number of components in an e-mail server device. Moreover, other components needed for a commercial embodiment of an e-mail server device that incorporates the components shown at 802 are omitted from FIG. 8 for clarity in describing the enclosed embodiments.

In general, at a hardware level, the device components 804, 808, 810, 814, and 816 function as described for the analogous device components 704, 708, 710, 714, and 716, respectively, shown in FIG. 7. In combination, however, the device components 804, 808, 810, 814, 816 of FIG. 8 operate as an e-mail server device. The communication interface 808, for example, might support more simultaneous connections than the communication interface 708, and the processing element 804 might be configured for a greater computational load as compared to the processing element 704. The file-storage component 810 might also be implemented with a memory capacity to support the operations of an e-mail server device, as described herein, that services a plurality of e-mail client devices.

As the e-mail server device 802 receives e-mail attachments with incoming e-mails for an e-mail thread, it saves the e-mail attachments to the file-storage component 810. For one embodiment, the file-storage component 810 is co-located with the e-mail server device 802. In another embodiment, the file-storage component 810 is remotely located and accessible to the e-mail server device 802 via the communication interface 808. The e-mail server device 802 also creates a current list of e-mail attachments for the e-mail thread and appends the list with each new e-mail attachment it receives.

When a participant uses an e-mail account to compose an e-mail using an e-mail client device, such as the e-mail client device 702, for example, the e-mail client device 702 uses the communication interface 708 to send a message to the e-mail server device 802 indicating that the e-mail is being composed. The message is received by the e-mail server device 802 through the communication interface 808, and the e-mail server device 802 prepares a list of received e-mail attachments for the e-mail account. For one embodiment, the list of received e-mail attachments, taken from the current list of e-mail attachments, only indicates e-mail attachments sent to the e-mail account.

The e-mail server device 802 provides the list of received e-mail attachments by sending it, using the communication interface 808, to the e-mail client device 702, where it is received through the communication interface 708 and presented, using the output device 712, to the participant using the e-mail account. The participant selects from the list of received e-mail attachments a set of outgoing e-mail attachments, which are those e-mail attachments he wishes to have attached to his outgoing e-mail. His selection is then communicated back to the e-mail server device 802. In one embodiment, his selection is sent to the e-mail server device 802 with his outgoing e-mail, and in another embodiment, his selection is sent to the e-mail server device 802 separately from his outgoing e-mail. After receiving both the participant's outgoing e-mail and his selection of outgoing e-mail attachments, the e-mail server device 802 attaches the selected set of outgoing e-mail attachments to the e-mail and sends the e-mail to the e-mail accounts to which the e-mail is addressed.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by an electronic computing device for managing e-mail attachments in e-mail communications, the method comprising:
determining that a second e-mail account is receiving from a first e-mail account a first e-mail, of an e-mail thread, having a first e-mail attachment;
determining that a second e-mail of the e-mail thread is being composed for the second e-mail account; and
responsively providing a first list of received e-mail attachments for the e-mail thread, wherein the first list indicates the first e-mail attachment.

2. The method of claim 1 further comprising detecting a selection of a first set of outgoing e-mail attachments from the first list of received e-mail attachments, wherein the first set of outgoing e-mail attachments is attached to the second e-mail.

3. The method of claim 2, wherein at least one e-mail attachment of the first set of outgoing e-mail attachments is an electronic link that points to an electronic file.

4. The method of claim 3, wherein the electronic link is a hyperlink.

5. The method of claim 4, wherein the hyperlink is a hyper-text-markup-language hyperlink or an extensible-markup-language hyperlink.

6. The method of claim 1 further comprising determining a current list of e-mail attachments received collectively by a plurality of e-mail accounts participating in the e-mail thread.

7. The method of claim 6, wherein the first list of received e-mail attachments is a subset of the current list of e-mail attachments.

8. The method of claim 7, wherein the first list of received e-mail attachments indicates only e-mail attachments received by the second e-mail account.

9. The method of claim 6 further comprising determining, for each e-mail attachment indicated in the current list of e-mail attachments, from which e-mail account the e-mail attachment originated.

10. The method of claim 9 further comprising determining which e-mail attachments indicated in the current list of e-mail attachments are modified versions of previously sent e-mail attachments.

11. The method of claim 10 further comprising determining, for each modified version of a previously sent e-mail attachment, from which e-mail account the modified version originated.

12. The method of claim 11, wherein the first list of received e-mail attachments indicates which e-mail account originated each listed e-mail attachment, and indicates which e-mail account originated each listed modified version of a previously received e-mail attachment.

13. The method of claim 12, wherein the first list of received e-mail attachments further indicates a most recent e-mail attachment from a series of subsequently modified e-mail attachments originating from a same previously received e-mail attachment of the e-mail thread.

14. The method of claim 6 further comprising:
determining that a third e-mail account is receiving from the second e-mail account the second e-mail having a second e-mail attachment of first set of outgoing e-mail attachments;
determining that the second e-mail is an initial e-mail in the e-mail thread to which the second e-mail attachment was attached; and
adding the second e-mail attachment to the current list of e-mail attachments.

15. The method of claim 14 further comprising:
determining that a third e-mail of the e-mail thread is being composed for the third e-mail account;
responsively providing a second list of received e-mail attachments for the e-mail thread, wherein the second list indicates the second e-mail attachment; and
detecting a selection of a second set of outgoing e-mail attachments from the second list of received e-mail attachments, wherein the second set of outgoing e-mail attachments is attached to the third e-mail.

16. An electronic computing device configured to manage e-mail attachments in e-mail communications, the electronic computing device comprising:
at least one communication interface configured to receive and send e-mail communications; and
a processing element operatively coupled to the at least one communication interface, wherein the processing element is configured to:
determine that a second e-mail account is receiving from a first e-mail account a first e-mail, of an e-mail thread, having a first e-mail attachment;
determine that a second e-mail of the e-mail thread is being composed for the second e-mail account;
responsively provide a list of received e-mail attachments for the e-mail thread, wherein the list indicates the first e-mail attachment; and
detect a selection of a set of outgoing e-mail attachments from the list of received e-mail attachments, wherein the set of outgoing e-mail attachments is attached to the second e-mail.

17. The electronic computing device of claim 16, wherein at least one e-mail attachment of the set of outgoing e-mail attachments is an electronic link that points to an electronic file.

18. The electronic computing device of claim 17, wherein the electronic file is stored on a file server that is co-located with the electronic computing device or communicatively coupled to the at least one communication interface of the electronic computing device through a network.

19. The electronic computing device of claim 16, wherein the electronic computing device is configured to operate as an e-mail server device.

20. The electronic computing device of claim 16, wherein the electronic computing device is configured to operate as an e-mail client device.
